(19) United States
(12) Patent Application Publication
(10) Pub. No.: US 2019/0257145 A1
(43) Pub. Date: Aug. 22, 2019

(54) A Corner Bracket

(71) Applicant: Louver-Lite Limited, Hyde (GB)

(72) Inventors: Andrew Greening, Hyde (GB); Antony Barnes, Hyde (GB)

(73) Assignee: Louver-Lite Limited, Hyde (GB)

(21) Appl. No.: 16/333,447

(22) PCT Filed: Sep. 26, 2017
(86) PCT No.: PCT/GB2017/052870

§ 371 Date: Mar. 14, 2019

(30) Foreign Application Priority Data
Sep. 26, 2016 (GB) 1616324.8

(51) Int. Cl. E06B 9/38; E06B 9/42; E06B 9/32; E06B 9/36

(52) U.S. Cl. CPC E06B 9/38; E06B 9/36; E06B 9/32; E06B 9/42

(57) ABSTRACT

A corner bracket for a window blind frame, the corner bracket including a central body portion and extending from the central body portion a first connector and a second connector, wherein the second connector is angled relative to the first connector; each connector includes a locating arm, a locking plate and a stop surface; and wherein the locking plate includes at least one outwardly projecting locking element.

The present invention relates to corner brackets and in particular to corner brackets for window blind frames.

It has become quite common for window blinds to be located within window blind frames. EP1727958 discloses an example of such a window blind frame. The use of a frame with a window blind provides an aesthetically pleasing arrangement and also addresses the technical problem of minimising light-strike around the sides and bottom of the blind substrate when the substrate is deployed and protecting the edge portions of the blind substrate in use.

Typically, the frame includes elongate frame members, which form the sides of the frame, and corner brackets which join adjacent ends of the frame members. The elongate frame members are cut to length and the ends are coupled to respective corner brackets via one or more fixings, such as screws.

However, such an arrangement can be time-consuming for the installer, as the screws have to be properly located and each screw tightened individually. The screws also add to the overall cost of the frame.

To address these problems, it is desired to produce a “push-fit” type corner bracket that provides a secure locking arrangement without the need for separate fixings.

According to a first aspect of the invention, there is provided a corner bracket for a window blind frame, the corner bracket including a central body portion and extending from the central body portion a first connector and a second connector, wherein the second connector is angled relative to the first connector; each connector includes a locating arm, a locking plate and a stop surface; and wherein the locking plate includes at least one outwardly projecting locking element.

According to the invention, the stop surface defines a contact surface against which an end of a frame member may be located. The stop surface aligns a slot defined in a surface of the frame member with the locking element. The locking element is prevented from disengagement with the slot by the locating arm of the respective connector being located within a corresponding channel defined by the frame member. Such an arrangement provides a secure locking arrangement between the bracket and a respective frame member without the need for separate fixings.

The angle between the first and second connectors is suitably from 10° to 170°, for example, from 45° to 135°, or from 60° to 120°. The angle may be substantially 90°.

In an embodiment of the invention, the first locking element projects in a direction perpendicular to the first locking plate, and the second locking element projects in a direction perpendicular to the second locking plate. The locking elements of this embodiment suitably project internally. The skilled person will appreciate that a corner bracket has internally facing sides (i.e. those sides which are located proximal to the area defined by the frame and which face towards the area defined within the frame) and externally facing sides (i.e. those sides which are located distal to the area defined by the frame and which face away from the area defined by the frame). Accordingly, in this embodiment, the locking elements project from the internally facing sides of the locking plates.

In an embodiment of the invention, each locking plate defines a substantially planar locking surface. Suitably, the respective locking element projects in a direction which is perpendicular to the plane of the locking surface.

In order to ensure that a wall of the frame member lies adjacent to a respective locking plate, each stop surface may include a locating tab, wherein the locating tab is parallel to the respective locking plate and spaced therefrom. In this embodiment, the locating tab and locking plate define between them a channel which is suitably sized and configured to receive therein a portion of a frame member wall. The locating tab ensures that the portion of frame member wall is located adjacent to and in contact with the locking plate.

In an embodiment of the invention as defined herein, the outwardly projecting locking element includes a sloped leading edge. Such an arrangement allows for the locking element to form a snap fit within the slot of the respective frame member. Thus, the locking plate and/or the wall of the frame member may be deflected slightly as it moves relative to the sloping leading edge until the locking element is located within the slot, at which point, the locking plate and/or the wall of the frame member is able to snap back to its non-deflected configuration. The trailing edge of the locking element is not sloped and therefore, it is not possible to disengage the locking element from the slot by urging the frame member in the reverse direction without manually deflecting the locking plate and/or the wall of the frame member. Accordingly, the leading edge of the locking element may be sloped or angled relative to the locking plate, and the opposite end of the locking element my provide a step or ridge relative to the locking plate. The arrangement of this embodiment provides a push-fit locking arrangement between the corner bracket and respective frame members.

The locating arm in use is located within a channel defined by the respective frame member. To accommodate a wall of the channel therebetween, the locating arm is suitably spaced from the locking plate. In such an arrangement, a portion of the frame member which defines a wall of the channel may be located within a gap defined between the locating arm and the locking plate.

According to a second aspect of the invention, there is provided a window blind frame comprising a pair of angled frame members having adjacent ends joined together by a corner bracket as defined anywhere hereinabove, wherein each frame member includes an inner wall which defines therein a slot and a body portion which defines a channel; the locating arm of a respective connector is located within the channel defined by each frame member; the inner wall of each frame member is located adjacent to a respective one of the locking plates; an end of each frame member contacts a respective one of the stop surfaces; and the slot of each frame member receives therein a respective locking element.

The skilled person will appreciate that the term “inner wall” refers to a wall of the frame member which in use is located on the internal side of the frame (i.e. located proximal to the area defined by the frame).

The angle between the pair of frame members may be as defined and described above.

In embodiments where the corner bracket includes locating tabs, a portion of the inner wall of each frame member is located between a respective locating tab and locking plate. As noted above, this ensures that a portion of the inner wall is located adjacent to and in contact with the locking plate.

In an embodiment of the second aspect of the invention, each locking element forms a snap-fit with the respective slot of the frame member. Suitably, the locking arrangement is a push-fit, wherein as the frame member is urged towards the stop surface of the corner bracket, the inner wall slides over the locking element until it is aligned with the slot defined by the inner wall, at which point, the locking snap fits into the slot. In such an embodiment, the locking elements suitably have leading edges which are sloped or angled relative to the locking plate.

The frame may comprise three frame members which together form a closed triangular frame in which each end of the frame members is connected to an adjacent end of another frame member, or which together form an open rectangular frame in which one side of the rectangle is open (i.e. includes no frame member) and two of the frame members include a corner element only at one end thereof.

Alternatively, the frame may comprise four frame members which together form a closed rectangular frame in which each end of the frame members is connected to an adjacent end of another frame member.

The skilled person will appreciate that frames having more than four sides are within the scope of the invention as defined herein, for example, it is known to provide 5-membered and six-membered frames (i.e. frames having 5 sides or 6 sides). Thus, the frames of the present invention may include 3, 4, 5, 6, 7 or 8 sides, for example. However, as windows tend to be rectangular or triangular (for example in conservatory roofs), the corresponding frames tend to be triangular or rectangular.

According to a third aspect of the invention, there is provided a combination of a window blind and a window blind frame as defined in the second aspect of the invention, wherein the window blind is secured to the window blind frame.

The window blind of the third aspect of the invention may be a roller blind, a vertical blind, a Venetian blind, a Roman blind, a cellular blind or a pleated blind.

The skilled person will appreciate that the features described and defined in connection with the aspect of the invention and the embodiments thereof may be combined in any combination, regardless of whether the specific combination is expressly mentioned herein. Thus, all such combinations are considered to be made available to the skilled person.

An embodiment of the invention will now be described, by way of example only, with reference to the accompanying drawings in which:

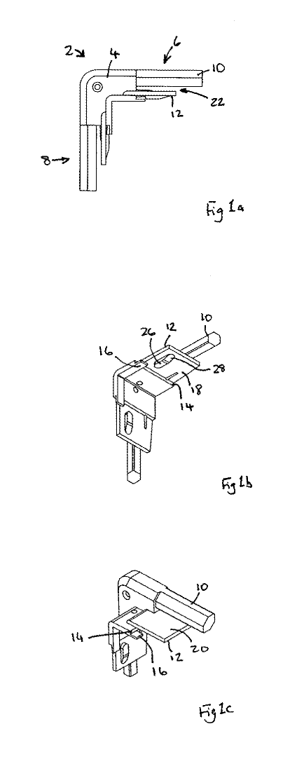

FIGS. 1a, 1b and 1c are views from different angles of a corner bracket according to a first embodiment of the invention;

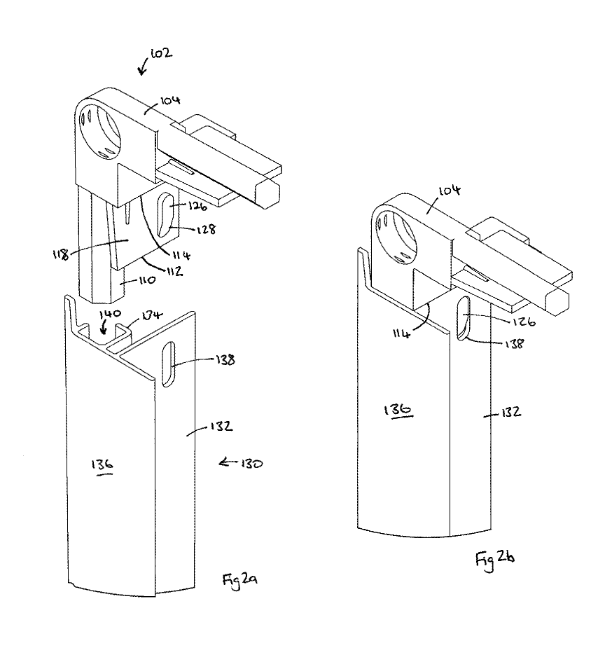

FIG. 2a shows a combination of a corner bracket according to a second embodiment of the invention and a frame member; and

FIG. 2b shows the corner bracket of FIG. 2a inserted into the frame member.

For the avoidance of doubt, the skilled person will appreciate that in this specification, the terms “up”, “down”, “front”, “rear”, “upper”, “lower”, “width”, etc. refer to the orientation of the components as found in the example when installed for normal use as shown in the Figures.

FIGS. 1a, 1b and 1c show a corner bracket 2 for a window blind frame. The corner bracket 2 comprises a central body portion 4 and extending perpendicularly from the central body portion 4 a first connector 6 and a second connector 8. The corner bracket 2 is formed from an injection moulded polymeric material.

Each of the connectors 6, 8 include a locating arm 10, a locking plate 12, a stop surface 14 and a locating tab 16. Each locking plate defines an internal surface 18 and an external surface 20

As can be seen from FIG. 1a, the locating arm 10 is spaced from the external surface 20 of each locking plate 12 such that a gap 22 is defined between them. Additionally, the locating tab 16 is spaced from the internal surface 18 of each locking plate 12 such that a second gap is defined between them (see FIG. 1c).

Projecting outwardly from the internal surface 18 of each locking plate 12 is a locking element 26. The locking element 26 includes a leading edge portion 28 which is sloped relative to the internal surface 18 of each locking plate 12.

FIG. 2a shows a frame member 130 in the form of an elongate aluminium extrusion. The frame member 130 includes an internal wall portion 132, a channel defining portion 134 and an outer wall portion 136.

The internal wall portion 132 defines a plurality of slots 138 along its length.

The channel defining portion 134 defines a longitudinal channel 140.

The corner bracket 102 shown in FIGS. 2a and 2b is substantially the same as the corner bracket 2 shown in FIGS. 1a, 1b and 1c, except that the corner bracket 102 features a slightly different central body portion 104 and the locating tab 16 shown in FIGS. 1a, 1b and 1c is omitted from the corner bracket 102. Otherwise, the corner bracket 102 is the same as the corner bracket 2 shown in FIGS. 1a, 1b and 1c. For ease of reference, the features which are common to the two corner brackets 2, 102 are given similar reference numerals, with the reference numerals of the corner bracket having a “100” prefix, such that the locating arm 10 of corner bracket 2 becomes locating arm 110 of the corner bracket 102, the locking plate 12 of the corner bracket 2 becomes locking plate 112 of the corner bracket 102 and so on.

To assemble a frame, a first frame member 130 is located adjacent to the corner bracket 102 such that the locating arm 110 is located within the channel 140 defined by the channel defining portion 134 and a part of the channel defining portion 134 of the frame member 130 is located within the gap 122 defined between the locking plate 112 and the locating arm 110. The first frame member 130 is then urged towards the central body portion 104 of the corner bracket 102. As the first frame member 130 moves towards the central body portion 104, the internal wall portion 132 lies adjacent to the internal surface 118 of the locking plate 112. As it continues to move forwards, the leading edge of the internal wall portion 132 contacts the leading edge portion 128 of the locking element 126. This deflects the locking plate 112 away slightly from the internal wall portion 132. When the leading edge of the internal wall portion 132 contacts the stop surface 114 of the corner bracket 102, the locking element 126 becomes aligned with one of the slots 138 defined by the internal wall portion 132 and the locking plate 112 is able to snap back to its rest configuration. In its rest configuration, the locking element 126 is located within the slot 138.

The location of the locking element 126 within the slot 138 prevents longitudinal displacement of the frame member 130 away from the corner bracket 102. In this way, a push-fit locking arrangement between the frame member 130 and the corner bracket 102 is provided.

The frame is completed by repeating the above steps for each corner of the frame.

1. A corner bracket for a window blind frame, the corner bracket including a central body portion and extending from the central body portion a first connector and a second connector, wherein the second connector is angled relative to the first connector; each connector includes a locating arm, a locking plate and a stop surface; and wherein the locking plate includes at least one outwardly projecting locking element.

2. A corner bracket according to claim 1, wherein the angle between the first connector and the second connector is from 10° to 170°.

3. A corner bracket according to claim 1, wherein each stop surface includes a locating tab, wherein the locating tab is parallel to the respective locking plate and spaced therefrom.

4. A corner bracket according to claim 1, wherein each locking plate defines a substantially planar locking surface.

5. A corner bracket according to claim 4, wherein the outwardly projecting locking element extends substantially perpendicularly from the plane of the locking surface.

6. A corner bracket according to claim 1, wherein the outwardly projecting locking element includes a sloped leading edge.

7. A corner bracket according to claim 1, wherein the locating arm and locking plate of each connector are spaced from each other.

8. A window blind frame comprising a pair of frame members having adjacent ends joined together by a corner bracket as defined in claim 1, wherein each frame member includes an inner wall which defines therein a slot and a body portion which defines a channel; the locating arm of a respective connector is located within the channel defined by each frame member; the inner wall of each frame member is located adjacent to a respective one of the locking plates; an end of each frame member contacts a respective one of the stop surfaces; and the slot of each frame member receives therein a respective locking element.

9. A window blind frame according to claim 8, wherein each stop surface of the corner bracket includes a locating tab and a portion of the inner wall of each frame member is located between a respective locating tab and locking plate.

10. A window blind frame according to claim 8, wherein each locking element snap-fits into a respective slot of the frame member.

11. A window blind frame according to claim 8, wherein the frame includes three frame members, wherein adjacent ends of the frame members are joined together by respective corner brackets.

12. A window blind frame according to claim 11, wherein the frame comprises four frame members having a rectangular arrangement, wherein adjacent ends of the frame members are joined together by respective corner brackets.

13. A combination of a window blind and a window blind frame according to claim 8, wherein the window blind is secured to the window blind frame.

14. A combination according to claim 13, wherein the window blind is a roller blind, a vertical blind, a Venetian blind, a Roman blind, a cellular blind or a pleated blind.
